(19) United States
(12) Patent Application Publication
(10) Pub. No.: US 2008/0247310 A1
(43) Pub. Date: Oct. 9, 2008

(54) Method of Improving Communication Between Mobile Nodes

(75) Inventors: Marco Ruffini, Dublin (IE); Andries Van Wageningen, Wijlre (NL); Hans-Jurgen Reumerman, Aachen (DE); Marco Roggero, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,522

(22) PCT Filed: Jan. 17, 2005
(86) PCT No.: PCT/IB05/50189

§ 371 Date: Jul. 28, 2006

(30) Foreign Application Priority Data
Jan. 29, 2004 (EP) 04100314.6

(51) Int. Cl. H04L 1/00

(52) U.S. Cl. 370/230

(57) ABSTRACT

To improve a method of improving communication between mobile nodes in an ad-hoc wireless network and in particular to reduce the amount of data to be transmitted, all the nodes are organized into application-specific clusters and the information that is relevant to each application is stored in the head element of the cluster.

The invention relates to a method of improving communication between mobile nodes in an ad-hoc wireless network.

In an ad-hoc network of mobile nodes that organizes itself for the purpose of allowing information to be exchanged between the nodes without a stationary controlling means, the messages between the individual nodes are exchanged wirelessly via radio links. An ad-hoc network of this kind is formed, inter alia, in road traffic by motor vehicles that are equipped with suitable transmitting/receiving devices and other devices known to those skilled in the art for analyzing or creating and, if necessary, for storing desired messages. Each of the motor vehicles can be looked upon as a mobile node of the ad-hoc network in this case. With networks of this kind, it is possible, for example, for an ambulance, when approaching a traffic intersection, to draw the attention of other vehicles to itself by the exchange of suitable pieces of information and to cause the intersection to be kept clear to allow the ambulance to travel through it quickly. Similarly, motor vehicles can exchange information on their respective speeds in order to avoid collisions when a vehicle is changing lanes or when it is threading its way into lane, and to stop congestion from building up when the density of traffic is high.

In a cluster, i.e. a local group of nodes that are able to communicate with one another via for example a radio link, one of the nodes is selected as a head element, known as a “cluster head” or “cluster controller” (CC). Communication between the nodes may for example take place by means of peer-to-peer connections familiar to those skilled in the art, using the 802.11a, 802.11b, DRSC or comparable wireless protocols. In distributed cluster networks, the data is distributed among all the members involved, which means that each node has the same amount and type of information. This is achieved by a continuous exchange of information between all the nodes. This being the case, a problem arises if a large amount of information is to be exchanged and a hazardous situation calls for a quick response from the participants, and from the network. In a case like this, there might, under certain circumstances, not be enough time available for all the information to be passed on to all the nodes and for all the nodes to be kept up to date on the latest state of the information. A reliability problem may also arise if the network is intended to make decisions relating to the common safety.

In the communication between the nodes, information can be exchanged for any desired applications, such as, for example, information on the road conditions or on the current speed and direction of travel of each node to enable a group of motor vehicles traveling at a uniform speed to be formed. Similarly, it is possible for information on a current obstruction to traffic or on the weather or on road conditions to be exchanged within a cluster on a network.

One type of communication between vehicles consists of a fully distributed system. This however requires a common structure for the data, as described in the publication by Eoin O'Gorman, University of Dublin: Using Group Communication to Support Inter-Vehicle Coordination (B. Eng. thesis), September 2002, which structure has to be continually updated to the latest status and distributed to all the users. In this method, a large number of messages are exchanged, which may lead to the response time of the system being slowed down to an extreme degree, thus enabling only low reliability to be ensured for safety-related applications.

The publication ETSI TS 101 7614, Broadband Radio Access Networks (BRAN), Hiperlan Type 2, Data link control layer, Part 4 Extension for Home Environment, June 2000, describes a method of forming clusters, but in this case the cluster formation takes place independently of the nature of the information exchanged.

In the publication by Lachlan B. Michael and Ryuji Kohnoy: Adaptive Data Class Structure for Efficient Inter-vehicle Communication, IEICE TRANS. INF. & SYST., Vol. E99-D, No. 55, there is an description of how data to be exchanged is to be given a priority in line with its relevance to safety and is to be hierarchically distributed in a corresponding manner, to save on the bandwidth required in wireless communication. Detailed items of information on the state of movement of a motor vehicle such as acceleration, direction of travel, braking, etc. are for example relevant only to the motor vehicles directly adjacent to it.

In the publication by Basu, P., Khan, N., Little, T. D. C.: A mobility based metric for clustering in mobile ad hoc networks; Distributed Computing Systems Workshop, 2001 International Conference on, 16-19 Apr. 2001, pages 413-418, a method of cluster formation is described, having a high data throughput and an enlarged range, which uses an algorithm to connect a plurality of clusters.

US 2002/0169846 A1 discloses a method of selecting various head elements for the central control of the nodes of a network wherein, as described in paragraph 13, data can be collected in a head element. However, what is described in this case is only the organization of the network into clusters controlled by head elements.

US 2002/0059017 A1 describes a method of organizing vehicles into groups, wherein each group is headed by a head vehicle that collects all the data on the other vehicles or on road conditions. However, what is created in this case is a centralized system in which the head vehicle receives all the information and the other vehicles in the group are subordinated.

The publication by Ioannou, Petros, University of Southern California: “Development and Experimental Evaluation of Autonomous Vehicles for Roadway/Vehicle Cooperative Driving” describes the setting up of a cluster from motor vehicles that are driving together. It does not contain any indication of the exchange of data with similar clusters.

What can be considered disadvantageous in the case of the known methods is that what are always exchanged are a large number of items of information that are available to all the participants, but not every node in a network needs to have access to all the possible items of information for it to be ensured that the node can, nevertheless, travel safety in road traffic.

It is an object of the invention to provide a method of improving communication between mobile nodes by which a reduction in the amount of data transmitted is achieved, to give a faster response time by the system as a whole and to increase reliability, particularly where it is information relevant to safety that is transmitted. This object is achieved by virtue of the features specified in claim 1.

The idea at the heart of the invention is that a dedicated cluster, e.g. of motor vehicles in road traffic, is formed for each kind of application. A specific application may relate only to information on the weather, and/or to the local road conditions, and/or to giving notice of obstructions at certain points, or the like. In this case, it is only information relating to this specific application that is passed on by the head element of the cluster to the members of the cluster, so that the members of the cluster all have information of the same status. No other information is exchanged in this cluster. For this purpose, the information relevant to each application is stored in the head element of the cluster. As soon as the head element of a cluster has been selected or appointed, each of the nodes in the cluster transmits a local hazard warning for example direct to the head element. The head element stores all the data received in a local database and likewise processes it locally. The results of this processing can then be passed on to all the associated nodes in the cluster. Hence the nodes act as sensors that collect information, whereas the head element acts as a central computer that collects the information received from the sensors and if necessary analyzes it. If a mobile node, which is for example approaching a group of motor vehicles in road traffic, wishes to be included in the cluster, it is thus able to call up from the head element the latest information on, for example, the road conditions.

The nature of the communication between the individual nodes, i.e. under what protocol the communication takes place, can be selected as desired by the person skilled in the art within the scope of the invention.

The advantage of the invention lies in the fact that the information exchanged within a cluster is now only the information required for this cluster, i.e. for this specific application, which means that the total amount of information that has to be exchanged in this cluster is reduced and hence the reliability of the system is increased. For example, it may be only information on general weather conditions that is exchanged in one cluster, and in another cluster, and in particular in a local cluster that is described below, it may be only information on a current obstruction to traffic on a highway. The method can be used both for exchanging local warning messages and also for cooperative driving, i.e. where a plurality of vehicles join together in a cooperative union to travel in unison at the same speed.

The characterizing features of advantageous embodiments of the invention are described in the dependent claims.

An embodiment that is specified in claim 2 makes it possible for a node, e.g. a motor vehicle in road traffic, to be part of a plurality of clusters, to enable it to receive a number of different types of information specific to respective applications. A motor vehicle that is joining a multi-lane freeway or motorway may for example be part both of the mobile cluster under whose specific application only weather information for the region being driven through at the time is exchanged, and of a local cluster that is formed in the region of the point of entry to the highway to prevent collisions between the motor vehicles on the freeway or motorway and the motor vehicles that are joining it.

Preferably, as claimed in claim 3, each node in the cluster passes on the application-specific information to the head element of the particular cluster as soon as the node detects a change in the situation relating to this application. Similarly, the head element makes available to all the members of the cluster the information that has been collected by said head element and stored therein, so that all the members of the cluster are at the same information status level or a newly added member can call up information of this latest status. For this, a newly added member can transmit to the head element of the cluster an enquiry as to what the nature of the information is in the cluster or in other words what application the cluster has been formed for.

Within the scope of the invention, the way of selecting the head element may be selected as desired by the person skilled in the art. As claimed in claim 4, it may take place either randomly or by following rules for mobile ad-hoc networks that can be laid down by the person skilled in the art. The selection of the head element preferably takes place in this case as a function of the application in relation to which information is exchanged in the cluster. For a local application for example, the head element selected is one that will be staying in the local region for as long as possible, to give the maximum possible safety and reliability in the transmission of data.

It is also proposed, as specified in claim 5, that mobile and quasi-stationary clusters are formed. A mobile cluster is formed for example for a given group of motor vehicles that are traveling in the same direction on a freeway or motorway, to give travel in unison at a constant speed and a constant inter-vehicle distance. A quasi-stationary cluster is formed, for example, to notify nodes in the region of the quasi-stationary cluster of a hazard point in the traffic, the hazard point being substantially fixed. It will be appreciated that a node may be a member both of a mobile cluster and of a quasi-stationary one.

Advantageously, before leaving the cluster the head element notifies the nodes of this and transmits the data stored in it to a new head element, as disclosed in claim 6. What is achieved in this way is that the application-specific data stored in the head element is not lost but is transmitted to the next head element, by which it is communicated in turn to all the nodes in the cluster. Preferably, what is appointed as the new head element is a member of the cluster that can be foreseen to be staying in the cluster for an adequate length of time.

It is nevertheless possible that, due for example to a local disruption to the working of the radio transmissions for exchanging data between the nodes of the network, the head element may go out of action unexpectedly, thus causing the information stored in it to be lost to the cluster. This may happen when, amongst other things, an information protocol for the exchange of data has not been terminated correctly, when an error message is transmitted from the head element to the other members of the cluster or when no information is passed on by the head element for a certain period of time. To avoid a total loss of data of this kind, it is proposed, as claimed in claim 7, that the head element collects and filters the data from all the nodes, i.e. amongst other things that it sorts out duplicated information of identical meaning. What is generated in this way, for all the members of the cluster, is a unified dataset that is smaller in size, which means that the transmission rates required for the exchange of information are further reduced.

For this purpose it is proposed, as claimed in particular in claim 8, that information that is important to the specific application is passed on by the head element to all the nodes, the said nodes storing the information received in their local databases so that, if the head element should go out of action unexpectedly, another node in the cluster can take its place as the head element, because of the information that it has stored in it. For the transmission of the shared information, it is proposed that this is done by the one-to-many or many-to-one method rather than by a peer-to-peer method, to enable the bandwidth required for the transmission of the data to be kept small. Once a new head element has been selected by any desired method, all the nodes send the information previously stored in them, which may differ, to the new head element, duplicated information being sorted out in the new head element, e.g. via a filter algorithm, to allow the original dataset to be recovered. This recovered dataset can then be passed on again by the new head element to all the members of the group.

It goes without saying that the method of improving communication between mobile nodes can be used with all types of flows of goods where self-organization of the goods being transported is required. The method is preferably used, as specified in claim 9, in the control of a flow of traffic so that an existing highway can be used by a maximum number of vehicles with the maximum safety.

These and other aspects of the invention are apparent from and will be elucidated with reference to the embodiments described hereinafter.

In the drawings:

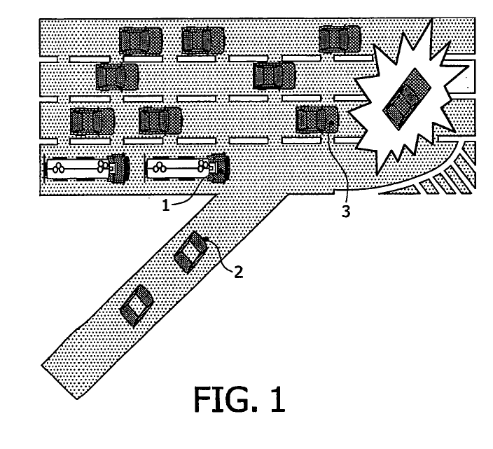

FIG. 1 shows a traffic situation in which there is a plurality of clusters.

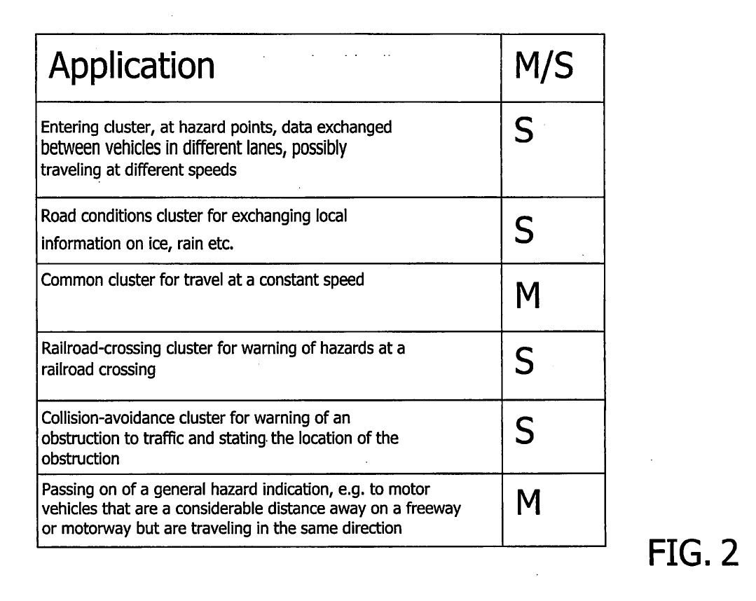

FIG. 2 is a table listing quasi-stationary and mobile clusters.

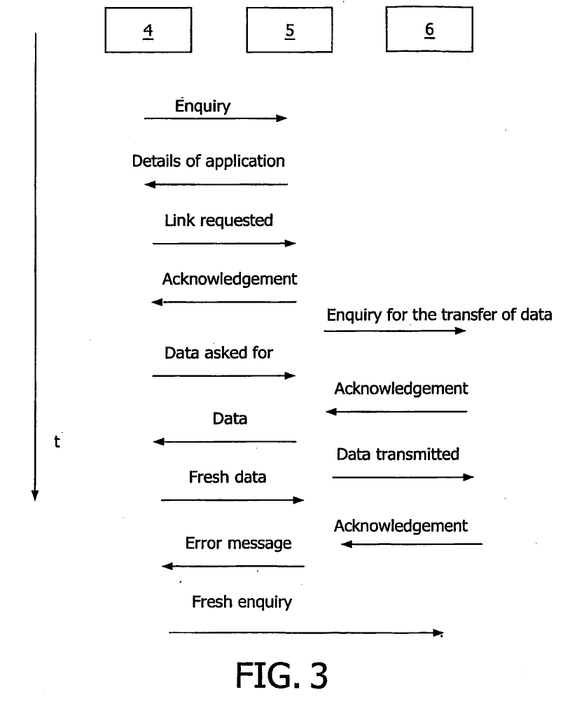

FIG. 3 is a flow chart of the exchange of information and

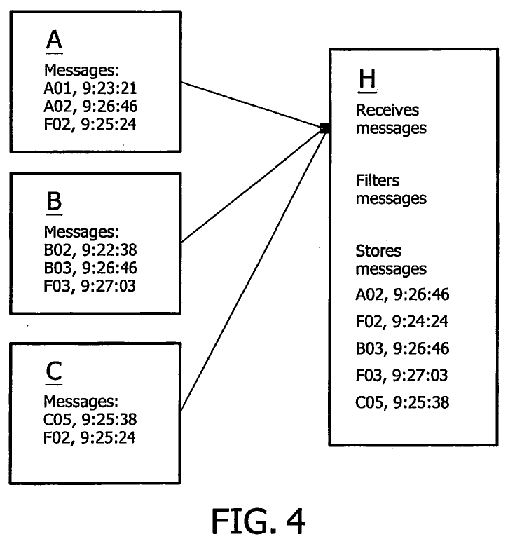

FIG. 4 shows the recovery of information.

FIG. 1 shows a typical traffic situation on a multilane highway. A number of trucks are driving along the right-hand lane at a substantially constant speed and these have joined together into a cluster for travel in unison, to drive at a constant speed and a constant inter-vehicle distance. The trucks are organized in this case into a mobile cluster, with truck 1 acting as the head element. What is exchanged in this cluster is for example only information on speed of travel and current position, to enable the constant mode of travel to be maintained with as small an exchange of information as possible. The trucks traveling in the right-hand lane and the motor vehicles that are joining the highway on the entering lane form a quasi-stationary joining cluster at the point where the entering lane is situated, the appropriate information, relating for example to location, speed and direction of travel, being exchanged between the members of this cluster to enable vehicles to thread their way onto the highway without running any risks. The head element of the cluster is the relatively slowly traveling motor vehicle 2 in the present case, which will be remaining at the point where the joining lane is located for a fairly long time. A third cluster is formed by further motor vehicles, what are exchanged in this cluster being local hazard indications, which are emitted for example by a motor vehicle that has broken down in a central lane. It is only these local hazard indications that are exchanged as information in this cluster. What acts as a head element is a motor vehicle 3 immediately adjacent the motor vehicle that has broken down, which motor vehicle 3 was the first to receive the information.

In the table in FIG. 2 can be seen a number of examples of mobile and quasi-stationary clusters or applications, with “S” standing for quasi-stationary clusters and “M” for mobile clusters.

In the flow chart in FIG. 3 can be seen, as a progression through time, the different pieces of information that are exchanged between the nodes, with the time axis t extending from top to bottom in FIG. 3 and with a new vehicle 4 to be added to a cluster being shown on the left, the head element 5 of the cluster in the center, and a member 6 of the cluster on the right. The new member 4 to be added may for example emit a warning message, in which case, for this purpose, it queries the head element 5 as to what specific application the head element 5 is responsible for. The new member 4 is told what this is by the head element 5. The new member 4 then asks for a link to be set up and this is acknowledged by the head element 5. At the same time, the head element 5 leaves the scene in this example and starts an enquiry for data to be transferred to the new head element 6. The relevant data is asked for by the new member 4 and is passed on by the head element 5. If the new member 4 has fresh data, this can be passed on to the head element 5. When leaving the cluster, the head element 5 transmits an error message to the member 4, whereupon the latter transmits a fresh enquiry to the new head element 6.

To avoid the loss of data, the head element 5 transmits an enquiry relating to the change of head element to a member 6 suitable for this purpose that is already present in the cluster. The database containing all the information relevant to the application concerned that is stored in the old head element 5 is then transmitted to the new head element 6 and is acknowledged by the latter, whereupon the new head element 6 acts as a head element in a corresponding way.

In FIG. 4 is shown an example of the recovery of data if, due to an area where radio transmission/reception is poor for example, a head element goes out of action briefly without an appropriate transmission of data having previously taken place to a new head element. A new head element H is first appointed, by a method that may be as desired within the scope of the invention, and all the members A, B, C of the cluster then pass on the information stored in them to the new head element H. This information is preferably filtered with an algorithm in the new head element H, to filter out in particular duplicated information or information that is not material. For the sake of simplification, each message or piece of information is defined to conform to a given standard. For example, each item of information may have assigned to it a header line that contains an identification of the original sender of the message, the number consecutively assigned to the message by the latter and the time when the message was transmitted. In this way, the pieces of information that are shown in FIG. 4 for example may be stored at different nodes A, B, C, and these are transmitted to a new head element H. The new head element H filters these pieces of information, as a result of which it is only the relevant information that is recovered and transmitted back again to all the nodes A, B, C.

### LIST OF REFERENCE NUMERALS:

A, B, C Nodes
H Head element of the cluster A, B, C
1, 2, 3 Head element of a cluster
4, 5, 6 Members of a cluster

1. A method of improving communication between mobile nodes in an ad-hoc wireless network, characterized in that all the nodes are organized into application-specific clusters and the information relevant to each application is stored in the head element of the cluster.

2. A method as claimed in claim 1, characterized in that each node becomes part of one or more clusters.

3. A method as claimed in claim 1, characterized in that each node in the cluster passes on the application-specific information to the head element or receives said information there from.

4. A method as claimed in claim 1, characterized in that the head element is selected at random or in accordance with given rules.

5. A method as claimed in claim 1, characterized in that mobile and quasi-stationary clusters are formed.

6. A method as claimed in claim 1, characterized in that, before leaving the cluster, a head element notifies the nodes of this and the data stored in the head element is transmitted to a new head element.

7. A method as claimed in claim 1, characterized in that the head element collects and filters the data from all the nodes.

8. A method as claimed in claim 7, characterized in that the filtered information that is important to the application is passed on to all the nodes and stored in them.

9. Use of a method as claimed in claim 1 for controlling a flow of traffic.
